(19) United States
(12) Patent Application Publication
(10) Pub. No.: US 2017/0149523 A1
(43) Pub. Date: May 25, 2017

(54) AGGREGATION OF MULTIUSER FRAMES

(71) Applicant: Intel IP Corporation, Santa Clara, CA (US)

(72) Inventors: Qinghua Li, San Ramon, CA (US); Po-Kai Huang, Santa Clara, CA (US); Xiaogang Chen, Beijing (CN); Huaning Niu, Milpitas, CA (US); Yuan Zhu, Beijing (CN)

(21) Appl. No.: 15/084,086

(22) Filed: Mar. 29, 2016

Related U.S. Application Data
(60) Provisional application No. 62/258,109, filed on Nov. 20, 2015.

(51) Int. Cl. H04L 1/00; H04W 72/04; H04B 7/04

(52) U.S. Cl. CPC H04L 1/0009; H04B 7/0452; H04W 72/04

(57) ABSTRACT

This disclosure describes systems, methods, and devices related to aggregation of multiuser frames. A device may determine a high efficiency field and one or more data frames, the one or more data frames including, at least in part, a first data frame and a second data frame, wherein the first data frame is associated with a first device and the second data frame is associated with a second device. The device may encode the first data frame and the second data frame in an aggregated data frame. The device may determine a resource unit associated with the aggregated data frame. The device may cause the aggregated data frame to be wirelessly transmitted to one or more devices using the resource unit, the one or more devices including at least in part the first device and the second device.

### CROSS-REFERENCE TO RELATED APPLICATIONS

This application claims the benefit of U.S. Provisional Application No. 62/258,109 filed Nov. 20, 2015, the disclosure of which is incorporated herein by reference as if set forth in full.

### TECHNICAL FIELD

This disclosure generally relates to systems and methods for wireless communications and, more particularly, enhancing Wi-Fi performance for applications involving the aggregation of multiuser frames.

### BACKGROUND

Wireless devices are becoming widely prevalent and are increasingly requesting access to wireless channels. A next generation WLAN, IEEE 802.11ax or High-Efficiency WLAN (HEW), is under development. HEW utilizes Orthogonal Frequency-Division Multiple Access (OFDMA) in channel allocation.

### BRIEF DESCRIPTION OF THE DRAWINGS

FIG. 1 depicts a network diagram illustrating an example network environment of an illustrative high efficiency signal field parallel coding system, in accordance with one or more example embodiments of the present disclosure.

FIG. 2 depicts an illustrative schematic diagram of sequential mapping between resource allocation and spatial stream allocation, in accordance with one or more example embodiments of the present disclosure.

FIG. 3 depicts an illustrative resource allocation table, in accordance with one or more example embodiments of the present disclosure.

FIG. 4 depicts an illustrative spatial stream allocation table, in accordance with one or more example embodiments of the present disclosure.

FIG. 5 depicts an illustrative spatial stream allocation table, in accordance with one or more example embodiments of the present disclosure.

FIGS. 6A-B depict illustrative schematic diagrams of a data frame aggregation system, in accordance with one or more example embodiments of the present disclosure.

FIGS. 7A-B depict an illustrative schematic diagram of an exemplary traffic indication map element, in accordance with one or more example embodiments of the present disclosure.

FIG. 8A depicts a flow diagram of an illustrative process for a data frame aggregation system, in accordance with one or more embodiments of the present disclosure.

FIG. 8B depicts a flow diagram of an illustrative process for a data frame aggregation system, in accordance with one or more embodiments of the present disclosure.

FIG. 9 illustrates a functional diagram of an example communication station that may be suitable for use as a user device, in accordance with one or more example embodiments of the present disclosure.

FIG. 10 is a block diagram of an example machine upon which any of one or more techniques (e.g., methods) may be performed, in accordance with one or more embodiments of the present disclosure.

### DETAILED DESCRIPTION

Example embodiments described herein provide certain systems, methods, and devices for providing signaling information to Wi-Fi devices in various Wi-Fi networks, including, but not limited to, IEEE 802.11ax (referred to as HE or HEW).

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

In some applications such as voice over internet-protocol (IP), mouse clicking applications, and display update applications, an access point (AP) may need to transmit many small packets to different users, (e.g., 60 bytes per user). Sending the packets using individual physical layer convergence protocol (PLCP) protocol data units (PPDUs) may result in a large overhead for the AP, for associated network(s), and for associated device(s). While some attempts using the physical (PHY) layer and media access control (MAC) layer to overcome these issues have been made, the approaches have limitations in terms of complexity, power consumption, and flexibility. For example, they may require many PHY layer changes in associated transceivers, while still not reducing overhead significantly. This may be, for example, due to each short data transmission still requiring a new set of automatic gain control (AGC) resets in addition to channel training, for example, using a high-efficiency short training frame (HE-STF) and a high-efficiency long training frame LTF (HE-LTF). The purpose of the AGC is to provide controlled signal amplitude at the output, despite variation of the amplitude at the input signal. Another weakness of the prior attempts is that the modulation coding scheme (MCS) may need to be the same for all users in an aggregated MAC protocol data unit (A-MPDU). Namely, the MCS of the user device with the lowest rate may need to be used, thus generating additional bottlenecks and overhead, and reducing throughput.

Example embodiments of the present disclosure relate to systems, methods, and devices for enhancing Wi-Fi performance for network applications having many small packets or frames.

In one aspect, a data frame aggregation system may be configured to utilize multiuser mode methods (e.g., OFDMA or multiuser multiple-input and multiple-output MIMO (MU-MIMO)) in order to aggregate small frames sent using a same PPDU. The data frame aggregation system may group small frames for user devices having similar channel qualities into an A-MPDU and sent over an OFDMA resource unit (RU) or one or more MU-MIMO spatial stream(s) using a particular MCS. The small data frames may be, for example, block acknowledgement frames for different user devices, respectively. Multiple block acknowledgement frames for multiple user devices may be aggregated into one MAC frame that is referred to as multiuser block acknowledgement frame (M-BA). This may minimize and enhance power consumption since lower overhead may be used when sending one or more small frames. Different OFDMA RUs or MU-MIMO streams may use different MCSs to send data for different groups of user devices with different channel qualities, respectively. That is, based on various factors, the data of one or more user devices may be grouped together and sent over OFDMA RU or MU-MIMO streams. These various factors include, in non-limiting examples, MCS values, channel quality, device type, device location, etc. It is understood that the above descriptions are for purposes of illustration and are not meant to be limiting.

In another aspect, the high efficiency signal B (HE-SIG-B) field in the PHY header may be used. The HE-SIG-B carries the device ID (also referred to as station (STA) ID) of each scheduled user device. A given user device may search the HE-SIG-B for its device ID. If a matching device ID is not found, the user device may stop decoding the subsequent data portion in order to save power. The disclosed systems and methods may thus achieve lower complexity architectures, provide multiple MCSs for different user groups, save the decoding power of unscheduled users, and reduce signaling and channel training overhead. In another aspect, one or more resource allocation (RA) indexes may be determined for indicating the number of users assigned to a particular RU and the number of streams utilized for each user. A transmitting device may utilize an RA index value to notify the receiving device of the number of users and/or the number of streams on a particular RU. In that sense, when the receiving device receives the data frame, the receiving device may analyze the RA index in order to determine the makeup of the RU and/or spatial streams that may be received by the receiving device.

In another aspect, a spatial stream allocation table for an RU having more than eight users (e.g., 10 users) may be determined in order to specify the number of spatial streams for each of the one or more user devices aggregated in one RU. In particular, because the number of MU-MIMO users per RU may, at most, be eight users, the spatial stream allocation table for more than eight users may include a stream allocation index that determines the number of streams that may be used by the one or all users in aggregation.

In another aspect, a spatial stream allocation table for an RU having less than eight users (e.g., four users) may be configured to introduce one or more stream allocation indexes to indicate the aggregation of the one or more users and the number of streams utilized by the users. An existing spatial stream allocation table may be enhanced by adding one or more entries to associate one or more stream allocation indexes with an aggregation of the one or more users.

In another aspect, a user identification list for user devices may be determined to indicate the user devices using a particular RU. The user identification list may contain at least in part a list of user devices utilizing the particular RU. For example, if there are four user devices utilizing an RU, the user identification list may include the device ID (also referred to as STA ID) of the user devices utilizing the RU. In that sense, when a receiving device receives the frame, it may analyze the user identification list to determine if it is included in that list. If there is a match in the ID, the receiving device may search that RU in order to extract the data sent to it. Additionally, the user identification list may reuse a traffic indication map element found typically in a beacon frame sent from a transmitting device to a receiving device (e.g., from an access point to a user device). A bitmap may be determined that allows a receiving device to determine whether a bitmap is set to 1 or 0 in order to determine whether the RU contains data addressed to that receiving device. A starting ID may be included to help the STA identify if a particular bit is the indication for itself.

In another aspect, an AP may use a multiuser block acknowledgment (M-BA) to respond and acknowledge multiple uplink transmissions received from one or more user devices in response to the AP sending a trigger frame to those one or more user devices. A trigger frame may be carried using a preamble (e.g., a legacy preamble or a high efficiency HEW preamble), along with other signaling, such as resource allocation, to coordinate the uplink OFDMA or MU-MIMO operation. A trigger frame is simply a frame that contains a preamble and other fields that may be sent from an AP scheduling the transmissions of user devices serviced by the AP. Essentially, the M-BA may be a multicast frame and signaling is required in the HE-SIG-B to direct the one or more user devices to decode the M-BA in the designated RU. The one or more aggregation of multiple data frames of different user devices in an RU may be also implemented in conjunction with the M-BA. The signaling in the HE-SIG-B may be a group ID. The group ID may be dynamically allocated in the trigger frame or statistically allocated through management frame. The signaling may use one or more RA indexes to indicate that a particular RU has a number of user devices' data frames. Once the one or more user devices receive the preamble of the M-BA frame, they may retrieve the group ID found in HE-SIG-B to determine whether the M-BA frame contains their data. For example, data frame 620 may be a data frame that is associated with a particular group ID in the HE-SIG-B. The data frame 620 may include an aggregation of multi-users' data (e.g., Users 1-4). Similarly, data frame 622 may be associated with another group ID in the HE-SIG-B and may include an aggregation of multi-users' data (e.g., Users 5-8). Data frame 624 may be associated with another group ID in the HE-SIG-B and may include an aggregation of multi-users' data (e.g., Users 9-11). When a receiving device determines that it belongs to a particular group ID based on decoding the HE-SIG-B, the receiving device may continue to decode the RU associated with that group ID. The RU may contain the M-BA for that receiving device and other user devices.

It is understood that the above descriptions are for purposes of illustration and are not meant to be limiting. Numerous other examples, configurations, processes, etc., may exist, some of which are described in greater detail below. Example embodiments will now be described with reference to the accompanying figures.

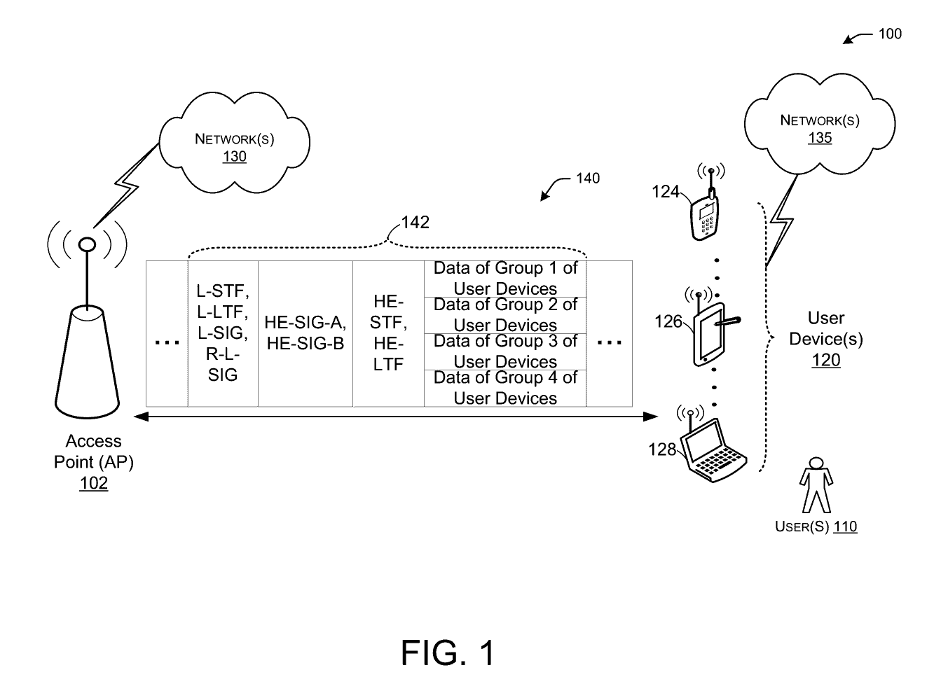

FIG. 1 is a network diagram illustrating an example network environment of a high efficiency signal field parallel coding system, according to some example embodiments of the present disclosure. Wireless network 100 may include one or more user devices 120 and one or more access point(s) (AP) 102, which may communicate in accordance with IEEE 802.11 communication standards, including IEEE 802.11ax. The user device(s) 120 may be mobile devices that are non-stationary and do not have fixed locations.

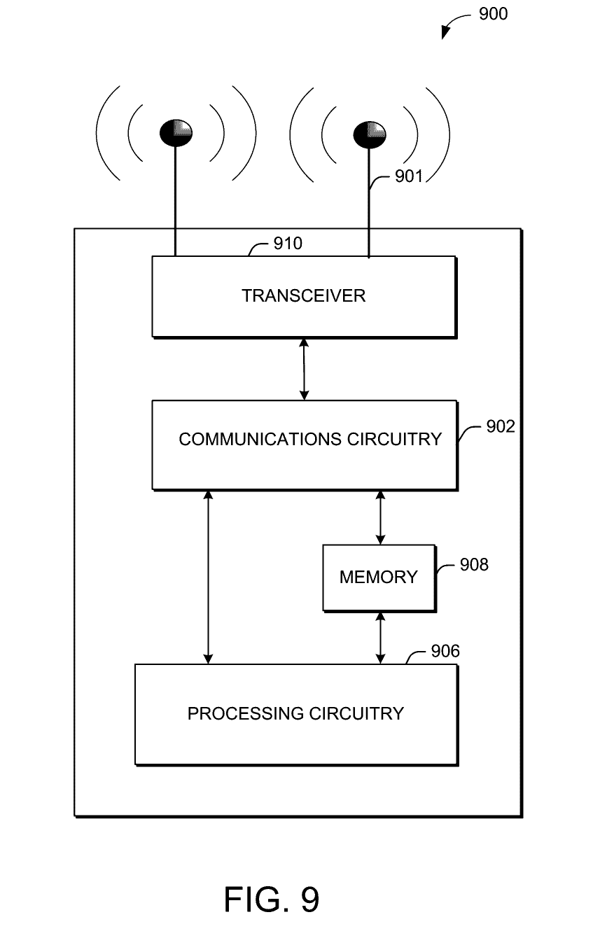

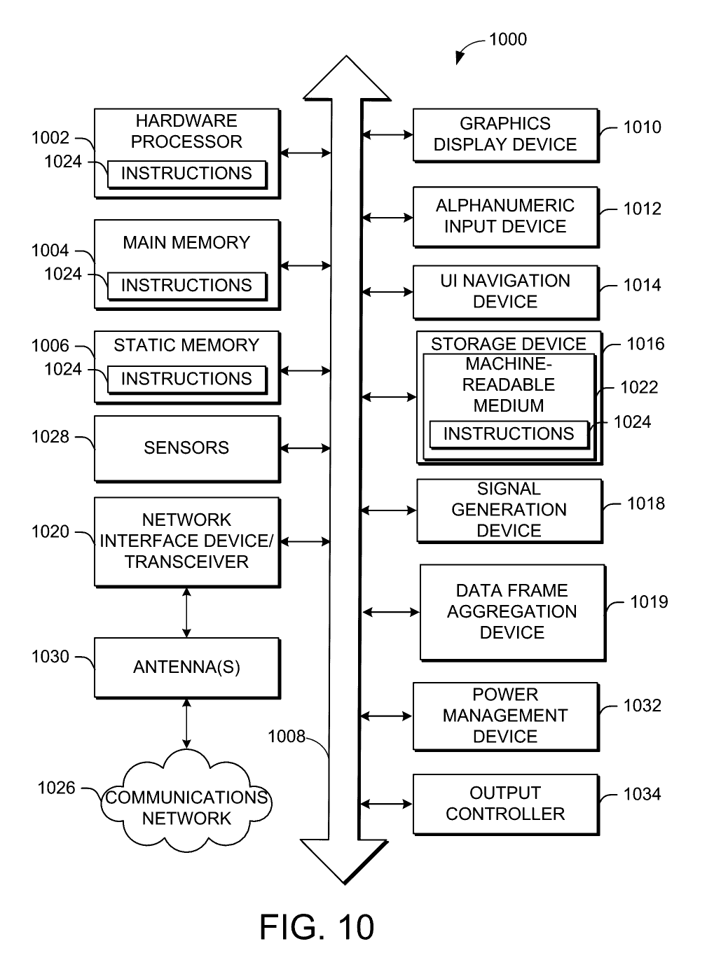

In some embodiments, the user device(s) 120 and the AP 102 may include one or more computer systems similar to that of the functional diagram of FIG. 9 and/or the example machine/system of FIG. 10.

The user device(s) 120 (e.g., 124, 126, or 128) may be operable by one or more user(s) 110. The user device(s) 120 may include any suitable processor-driven user device including, but not limited to, a desktop user device, a laptop user device, a server, a router, a switch, an access point, a smartphone, a tablet, a wearable wireless device (e.g., bracelet, watch, glasses, ring, etc.), and so forth.

Any of the user device(s) 120 (e.g., user devices 124, 126, 128), and the AP 102 may be configured to communicate with each other via one or more communications networks 130 and/or 135 wirelessly or wired. Any of the communications networks 130 and/or 135 may include, but are not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128), and the AP 102 may include one or more communications antennas. Communications antennas may be any suitable type of antenna corresponding to the communications protocols used by the user device(s) 120 (e.g., user devices 124, 126, and 128), and the AP 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, or the like. The communications antenna may be communicatively coupled to a radio component to transmit and/or receive signals, such as communications signals to and/or from the user devices 120.

Any of the user devices 120 (e.g., user devices 124, 126, 128), and the AP 102 may include any suitable radio and/or transceiver for transmitting and/or receiving radio frequency (RF) signals in the bandwidth and/or channels corresponding to the communications protocols utilized by any of the user device(s) 120 and the AP 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g., 802.11b, 802.11g, 802.11n, 802.11ax), 5 GHz channels (e.g., 802.11n, 802.11ac, 802.11ax), or 60 GHZ channels (e.g., 802.11ad). In some embodiments, non-Wi-Fi protocols may be used for communications between devices, such as Bluetooth, dedicated short-range communication (DSRC), ultra-high frequency (UHF) (e.g., IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and a digital baseband.

Typically, when an AP (e.g., AP 102) establishes communication with one or more user devices 120 (e.g., user devices 124, 126, and/or 128), the AP may communicate in the downlink direction by sending data frames. The data frames may be preceded by one or more preambles that may be part of one or more headers. These preambles may be used to allow the user device to detect a new incoming data frame from the AP. A preamble may be a signal used in network communications to synchronize transmission timing between two or more devices (e.g., between the APs and the user devices).

A resource unit may be a bandwidth allocation on an operating channel in time and/or a frequency domain. For example, with respect to the AP assigning resource units, in a frequency band of 20 MHz, there may be a total of nine resource units, each of the size of a basic resource unit of 26 frequency tones. The AP 102 may assign one or more of these resource units to one or more user device(s) 120 to transmit their uplink data. It is understood that the frequency band, and the number of resource units and frequency tones may be different.

Various modulation schemes and coding rates may be defined by a wireless standard, which may be represented by a modulation and coding scheme (MCS) index value. MCS index values may be used to determine the likely data rate of a Wi-Fi connection during a wireless communication between two devices (e.g., between the AP 102 and a user device 120). The MCS value essentially determines the modulation type (e.g., BPSK, QPSK, 16-QAM, 64-QAM), the coding rate (e.g., ½, ⅔, ¾, ⅚) that is possible when connecting to an access point (e.g., AP 102), where BPSK stands for binary phase shift keying, QPSK stands for quadrature phase shift keying, and QAM stands for quadrature amplitude modulation). It is understood that modulation is the method by which data is communicated through the air. The more complex the modulation, the higher the data rate. More complex modulations may require better conditions such as less interference and a good line of sight. The coding rate may be an indication of how much of a data stream is actually being used to transmit usable data. This may be expressed as a fraction with the most efficient rate being ⅚ or 83.3% of the data stream being used. The actual MCS may depend on variables such as hardware design and local interferences that may affect the rate and the network performance during the communication. For example, if a wireless or Wi-Fi connection cannot be maintained when there are too many errors being experienced during communication between the two devices, the MCS value may be lowered by selecting a different modulation type and/or coding rate in order to reduce the error rate. Although the MCS may indicate the data rate of the wireless or Wi-Fi connection, it may not determine the actual throughput of the network.

During data communication between a transmitting device and a receiving device, the transmitting device may select the number of spatial streams that may be used for transmitting data to the receiving device. The transmitting device may also determine the number of user specific parts that may be associated with the data be transmitted. Based at least in part on the number of users and the number of streams, the transmitting device may determine a spatial configuration field that is associated with the number of spatial streams used by one or more user devices. The spatial configuration field may be encoded by the transmitting device in order to notify the receiving device of how the spatial streams are used, to allow the receiving device to determine how the spatial streams were selected by the transmitting device when transmitting the data. For example, if there are two user devices, and three spatial streams are used to transmit data, the transmitting device may configure the spatial configuration field to indicate that the first user device is utilizing two streams and the second user device is utilizing one stream. It is understood that the transmitting device may select various values for the spatial configuration field to indicate various setups for utilizing the spatial streams when transmitting data.

In one embodiment, and with reference to FIG. 1, an HEW preamble (e.g., preamble 140) may include one or more fields 142, such as a legacy short training field (L-STF), a legacy long training field (L-LTF), a legacy signal field (L-SIG), a repeated legacy signal field (R-L-SIG), a high efficiency signal A HE-SIG-A field and a high efficiency signal B (HE-SIG-B) field, a high efficiency, short training field (HE-STF), a high efficiency long training field (HE-LTF), or other fields not depicted in preamble 140. It is understood that the above acronyms may be different and are not to be construed as a limitation because other acronyms may be used for the fields included in an HEW preamble.

The HE-SIG-B field may describe attributes of the one or more frames, such as the channel width, the modulation and coding, and whether the frame is a single- or multiuser frame. The HE-SIG-B field may include a common part and one or more user specific parts. It understood that a user specific part refers to a device specific part. For example, the common part may be common to all user devices, and the user specific parts may be specific to each user device receiving at least one of the one or more frames. The common part includes information for all users in the current PLCP protocol data unit (PPDU), and the user specific part includes the specific information for each specific user. It is understood that PLCP stands for physical layer convergence protocol.

In one embodiment, and as shown in FIG. 1, one or more user device data may be grouped and sent in a preamble from a transmitting device to a receiving device based at least in part on a predetermined grouping of the one or more user devices. The preamble 140 may be transmitted from the AP 102 to one or more user devices 120 on a communication channel. The communication channel may be of various frequency bandwidths (e.g., 40/80/160 MHz, etc.). The preamble 140 may include the one or more fields 142, where the one or more fields 142 may include data associated with the one or more user devices 120. The data may be grouped and transmitted at various frequencies or in various spatial streams. For example, one or more groups of user devices (e.g., user groups 1, 2, 3, and 4 may use different resource units (RUs) in terms of frequency or different spatial streams to transmit data associated with the one or more user devices 120. For example, user group 1 may include data for three user devices, user group 2 may include data for two user devices, user group 3 may include data for four user devices, and user group 4 may include data for one user device. Each of the user groups may contain a grouping or an aggregation of small frames that may include user specific data. Each of the user groups may be grouped based at least in part on similar characteristics between the users within the user group. Small frames associated with one or more user devices 120 having similar channel qualities may be aggregated into an A-MPDU and sent over an OFDMA RU or one or more MU-MIMO spatial stream(s). Different OFDMA RUs or MU-MIMO streams may use different MCSs to send data for different groups of users with different channel qualities, respectively. The characteristics may include, in non-limiting examples, MCS values, channel quality, device type, device location, etc. It is understood that the above descriptions are for purposes of illustration and are not meant to be limiting. Since the HE-SIG-B carries the device ID of each scheduled user devices, a given user device that receives the preamble 140 may search the HE-SIG-B for its ID. If a matching ID is not found, the user device may stop decoding the HE-SIG-B in order to save power.

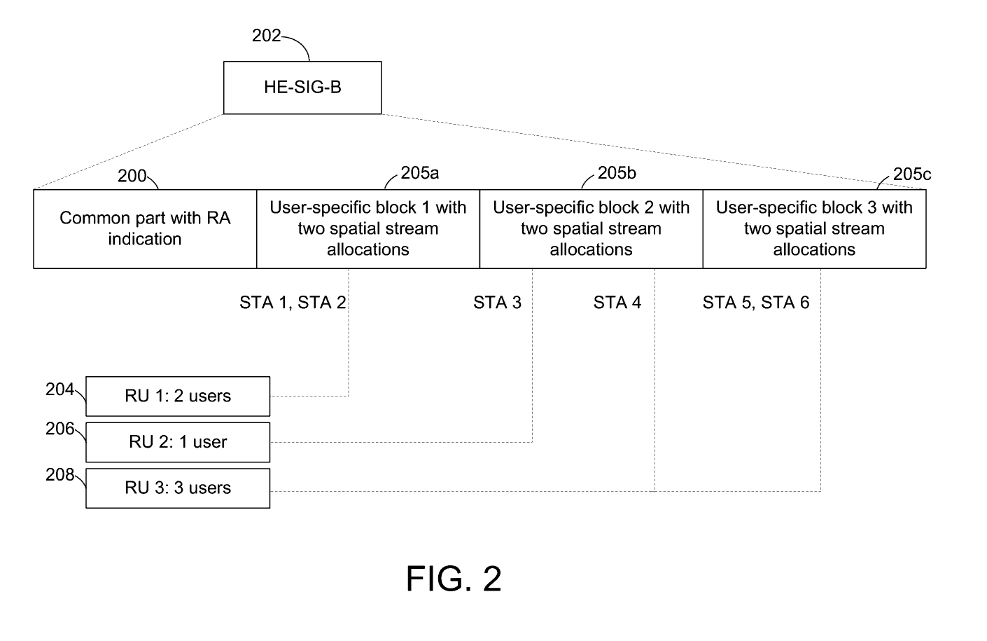

FIG. 2 depicts an illustrative schematic diagram of sequential mapping between resource allocation (RA) and spatial stream allocation, in accordance with one or more example embodiments of the present disclosure.

In one embodiment, user groups of users may be associated with a particular RU in frequency or may be associated with one or more particular spatial streams. The frequency partitioning may be indicated based at least in part on the common part (e.g., common part 200) of the HE-SIG-B. Specifically, the common part 200 of the HE-SIG-B may include an RA index that may indicate the user specific block allocations with respect to spatial streams and/or RUs. The RA indexes may indicate the type of RU (e.g., 26-tone RU, 52-tone RU, 106-tone RU, 242-tone RU, etc.). In addition, the RA indexes are configured to indicate the number of user specific blocks using the particular RU. For example, an RA index may indicate that RU 204 may carry data for two user devices (e.g., STA 1 and STA 2), and RU 204 may be associated with two spatial streams. Similarly, user specific block 205b may have an aggregation of two user specific blocks (e.g., STA 3 and STA 4) utilizing two spatial streams. RU 206 may be associated with user specific block 205b and may contain data for one user device (e.g., STA 3). The user specific block 205b may send the data for STA 4 using RU 208. As shown in the example of FIG. 2, RU 208 may be associated with three user devices (e.g., STA 4, STA 5, and STA 6).

The RU type used to transmit one or more user data may be greater than a 106-tone RU since multiple stream transmission may only be allowed on a 106-tone RU or larger. For example, the 26-tone RU may be used for single stream transmission and may not be associated with multiple stream transmissions. Knowing the number of user devices per RU allocation and the number of spatial streams for a user specific block may assist the receiving device to determine whether to decode a particular received frame.

Once the number of users is specified for each RU, the user specific blocks (e.g., blocks 205a-205c) of the user devices can be sequentially organized in the HE-SIG-B. For simplicity, the existing format of user specific blocks for single user (SU) and multiple users (MUs) can be reused for the aggregated users sharing the same RU. For overhead reduction, the user specific blocks (e.g., blocks 205a-205c) of the aggregated user devices may be shorter than the user specific block of a normal SU and MU (not shown). This may be because the aggregated users sharing the same RU may share the same modulation/coding scheme (MCS). Therefore, the same MCS may not need to be specified multiple times, thus saving overhead. Furthermore, the data frames of the aggregated users may be sent in the same order as they are specified in HE-SIG-B. This may simplify the searching process for the user's data (e.g., user ID) by a given user device.

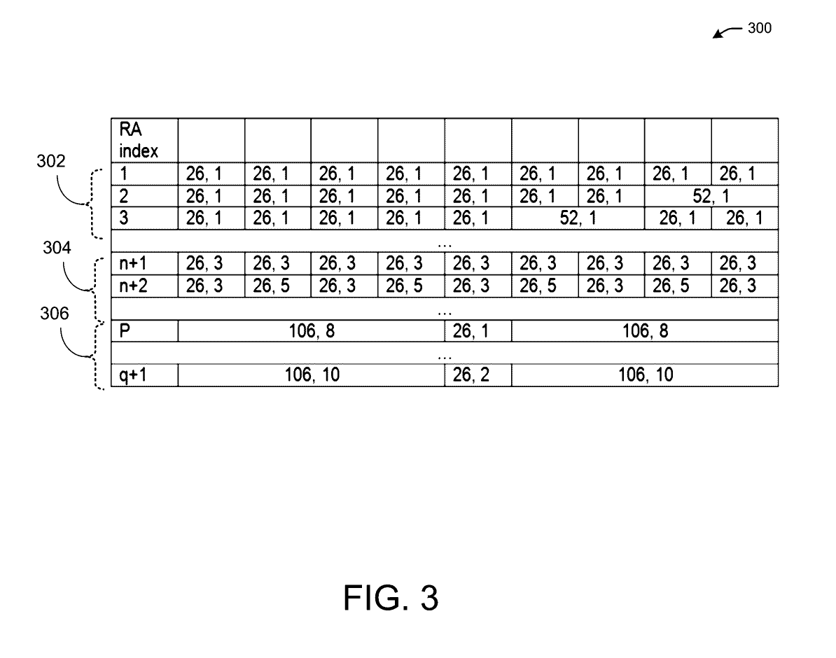

FIG. 3 depicts an illustrative resource allocation (RA) table 300 for HE-SIG-B for an exemplary (but non-limiting) 20 MHz channel or sub-channel, in accordance with one or more example embodiments of the present disclosure.

An RA index may indicate the number of user devices on a per RU basis. For example, the (i,j)-th entry in table 300 denotes that the RU has j subcarriers (or tones) and that j user(s) share the RU. For example, rows 302 show that RA index 1 has nine (26, 1) pairs indicating that there are up to nine users, each user using a 26-tone RU and each 26-tone RU carrying data for one user. Similarly, RA index 2, has seven (26, 1) pairs and one (52, 1) pair, indicating that seven users are using 26-tone RUs and one user is using a 52-tone RU.

In one embodiment, for aggregating small frames from multiple users as shown and described in FIG. 2, a smaller RU, such as a 26-tone RU, may be used, which can be further specified to only allow single stream transmission. As explained above, in some embodiments, multiple stream transmission may only be allowed on a 106-tone RU and larger. Therefore, indexes are added in the RA table, which may indicate that multiple users share the small RU, (e.g., 26-tone RUs and 52-tone RUs). Rows 304 and 306 show additional RA indexes that may be determined in accordance with one or more embodiments of the present disclosure. For example, at RA indexes n+1 and n+2, where n is an integer, there are multiple 26-tone RUs that have either 3 or 5 users sharing each 26-tone RU. However, each 26-tone RU may only utilize one spatial stream Moreover, the ambiguity may be eliminated between multiuser aggregation and MU-MIMO operation for 26-tone and 52-tone RUs as shown in this example, because MU-MIMO is not allowed in 26-tone and 52tone RUs. That is, if multiuser aggregation is used, then the RU must be a 106-tone RU or greater. For example, in case multiple spatial streams are used, e.g., using MU-MIMO, a 106-tone RU or greater may be used. In rows 306, RA indexes are shown having at least one 106-tone RU with aggregations of multiple user devices. For example, an entry of (106, 8) may be utilized to inform a receiving device that a 106-tone RU is used having data from eight users. However, since there may be multiple spatial streams used, it may be necessary to inform the receiving device of the number of spatial streams. It is understood that the above descriptions are for purposes of illustration and are not meant to be limiting.

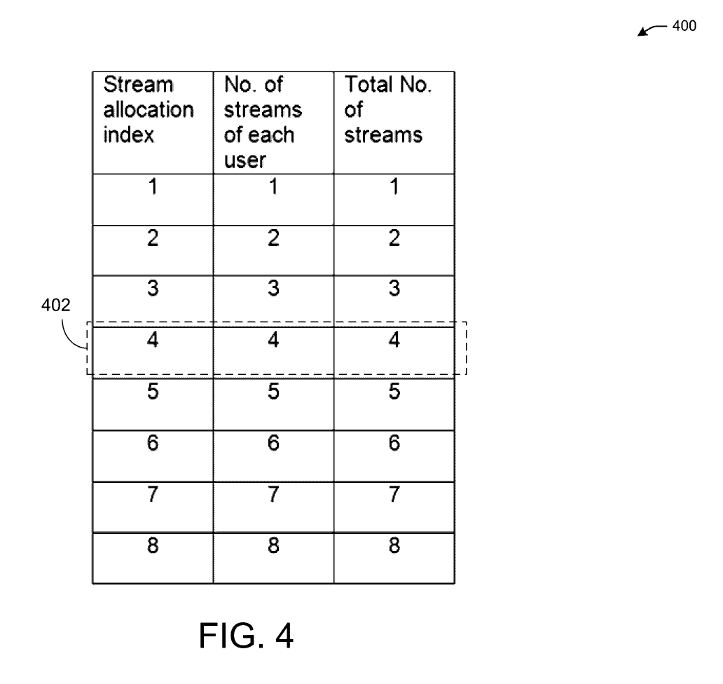

FIG. 4 depicts an illustrative spatial stream allocation table 400 for an exemplary RU with more than eight users (e.g., 10 users) in accordance with the present disclosure.

In one embodiment, the data frame aggregation system may determine a spatial stream allocation table to indicate the number of streams utilized in case MU-MIMO is used. It is understood that the number of MU-MIMO users per RU may at most be eight users. For supporting multiuser frame aggregation for a MIMO transmission or an RU with more than 52 tones, entries in the RA table and the spatial stream allocation table 400 may be added. For example, the added RA index q+1 in FIG. 3, where q is an integer, indicates that the 106-tone RU carries data for 10 user devices. Because the number of MU-MIMO users in this exemplary RU may at most be 8, this RA index indicates a multiuser frame aggregation where 10 user devices' frames are aggregated in one RU. The spatial stream allocation table 400 for the 10-user case further specifies the actual number of spatial streams for each of the 10 users. For example, row 402 shows that if the stream allocation index is 4, and the RA index shows that a 106-tone RU is used with 10 user devices, then all 10 user devices share the same four spatial streams, where their data is aggregated in the MAC payload. It is understood that the above descriptions are for purposes of illustration and are not meant to be limiting.

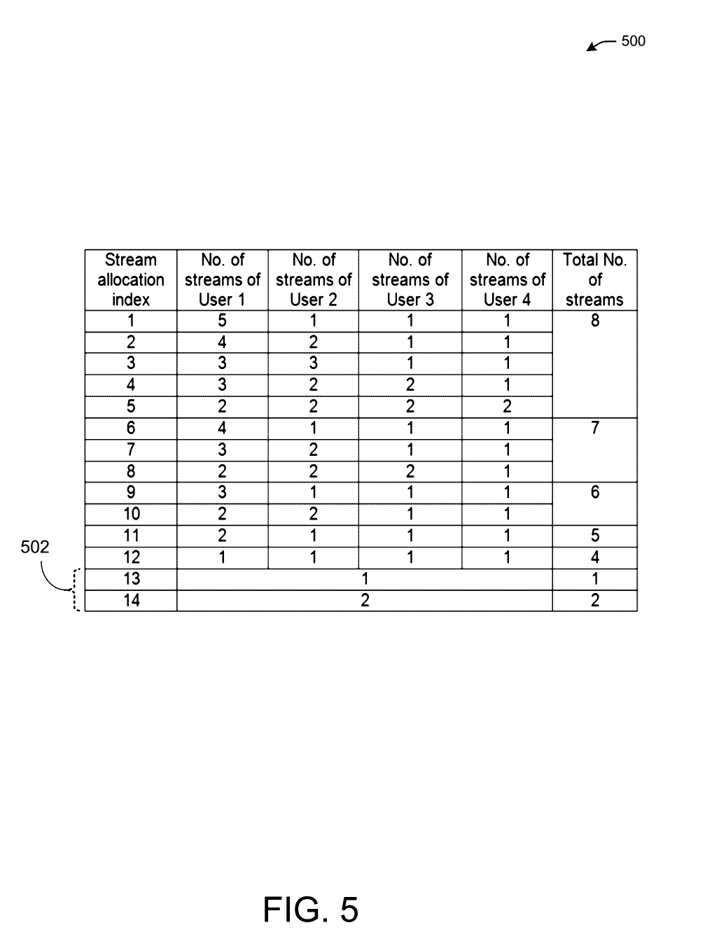

FIG. 5 depicts an illustrative spatial stream allocation table 500 for an exemplary RU for four user devices, in accordance with one or more example embodiments of the present disclosure.

In one embodiment, if multiuser frame aggregation is desired for eight or fewer users on one RU, the signaling mechanism for MU-MIMO may be reused and entries only need to be added to the existing tables for spatial stream allocation. Both MU-MIMO and multiuser frame aggregation have multiple users sharing the same RU. The indication of multiuser frame aggregation may be the same as that of MU-MIMO except the two use different indexes in the spatial stream allocation table. This removes the need to use group ID for the multiuser frame aggregation because the STA ID of each aggregated user device is specified in its user specific part. A device receiving an aggregated multiuser frame can check the STA ID to tell whether it is addressed to it or not. Dynamically defining the group ID and passing it from the MAC layer to PHY layer increase implementation complexities.

For example, table 500 shows an exemplary spatial stream allocation table for four user devices. Typically, the spatial stream allocation table may have various entries, some of which are not used. The data frame aggregation system may use one or more entries from the unused entries to indicate the aggregation mode. For example, rows 502 show stream allocation indexes 13 and 14, which are added in order to specify the number of streams used by the aggregated users. For example, stream allocation index 13 indicates that there is one spatial stream for the RU and there can be four user devices' frames aggregated in the RU (e.g., Users 1-4 as shown in table 500). Index 14 indicates that there can be two spatial streams for the RU and that four user devices' frames are aggregated in the RU and jointly carried by the two streams. It is understood that the above descriptions are for purposes of illustration and are not meant to be limiting.

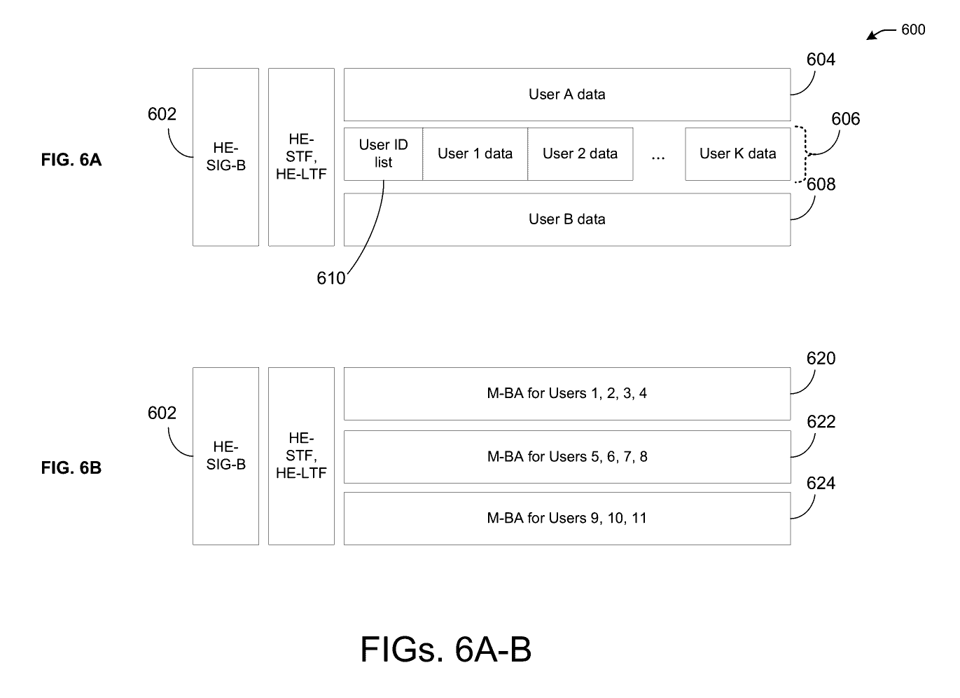

FIGS. 6A-B depict illustrative schematic diagrams of a data frame aggregation system, in accordance with one or more example embodiments of the present disclosure.

FIG. 6A shows an example preamble 600 that may include an HE-SIG-B field 602 and three data frames 604, 606, and 608. The unicast and aggregated data frames may be sent in the same PPDU. The data frames 604 and 608 may carry user data for user device A, and user device B respectively. These data frames may be considered unicast data frames. Data frame 606 may be an aggregated data frame that includes multiuser data frames from multiple user devices. The HE-SIG-B field 602 may contain user device IDs (or STA IDs) of the user devices in the unicast frames. That is the HE-SIG-B field 602 may include the user device ID of user device A and user device B.

In one embodiment, a receiving device may check the HE-SIG-B field (e.g., HE-SIG-B field 602) in order to determine whether the receiving device's ID is found in the HE-SIG-B field. If the user device's ID is addressed in the HE-SIG-B, the user device may find its allocation accordingly. If the user device's ID is not addressed and a group/multicast/broadcast ID is used for an RU or for spatial stream(s) within a RU that carries the aggregated frame of multiple stations, the user device may check the group/multicast/broadcast ID. If the user device belongs to the group or needs to receive the group/multicast/broadcast messages, the receiver station may decode the RU or spatial streams allocated for the group/multicast/broadcast ID.

For example, if a receiving device (e.g., user A or user B) determines that its device ID is found in the HE-SIG-B field, the receiving device may determine its data frame (e.g., unicast data frame 604 and 608) and may decode the data frame. However, if the receiving device does not find its user device ID in the HE-SIG-B field, it may be possible that an aggregated data frame contains the data associated with the receiving device. For example, user devices, 1, 2, . . . k, where k is an integer, that may have their user data in an aggregated data frame (e.g., data frame 606), may not automatically find their user device IDs in the HE-SIG-B field 602. It should be understood that in multicast or broadcast scenarios where a news broadcast is sent to multiple user devices, the multicast or broadcast ID may be found in the HE-SIG-B field. However, the data frame associated with the multicast or broadcast ID may be considered a unicast data frame and not an aggregated data frame because the data frame contains information that should be decoded by all receiving devices receiving the data frame.

In one embodiment, the data frame aggregation system may determine a user device ID list (e.g., user ID list 610) for group, multicast, or broadcast IDs that may be used for the aggregated data frames. For example, the data frame 606 may include user ID list 610 that may indicate the user device IDs of the multiusers that may be aggregated in the data frame 606. The purpose of the user device ID list 610 is to allow a receiving device that may receive preamble 600 to decode an aggregated data frame (e.g., data frame 606) only if the receiving device is able to find its user device ID in the user ID list 610.

Referring to FIG. 6B, there is shown another example of preamble 600 that may include the usage of a multiuser block acknowledgment (M-BA) in accordance with one or more embodiments of the present disclosure. For example, an AP may utilize an M-BA frame to respond and acknowledge multiple uplink transmissions received from one or more user devices in response to the AP sending a trigger frame to those one or more user devices. A trigger frame may be carried using a preamble (e.g., a legacy preamble or a high efficiency HEW preamble), along with other signaling, such as resource allocation, to coordinate the uplink OFDMA operation. A trigger frame is simply a frame that contains a preamble and other fields that may be sent from an AP scheduling user devices' transmissions. Essentially, the M-BA may be a multicast frame, and signaling is required in the HE-SIG-B 602 to direct the one or more user devices to decode the M-BA in the designated RU. The one or more aggregation of multiple data frames of different user devices in an RU also may be implemented in conjunction with the M-BA. The signaling in the HE-SIG-B 602 may be a group ID that may be allocated in the trigger frame. The signaling may use one or more RA indexes to indicate that a particular RU has a number of user devices' data frames. Once the one or more user devices receive the M-BA, they may retrieve the group ID found in HE-SIG-B 602 to determine which frame contains their data. For example, data frame 620 may be a data frame that is associated with a particular group ID in the HE-SIG-B 602. The data frame 620 may include an aggregation of multiusers' data (e.g., users 1-4). Similarly, data frame 622 may be associated with another group ID in the HE-SIG-B 602 and may include an aggregation of multiusers' data (e.g., users 5-8). Data frame 624 may be associated with another group ID in the HE-SIG-B 602 and may include an aggregation of multiusers' data (e.g., users 9-11). When a receiving device determines that it belongs to a particular group ID based on decoding the HE-SIG-B 602, the receiving device may continue to decode the RU associated with that group ID. The RU may contain the M-BA for that receiving device and other user devices. It is understood that the above descriptions are for purposes of illustration and are not meant to be limiting.

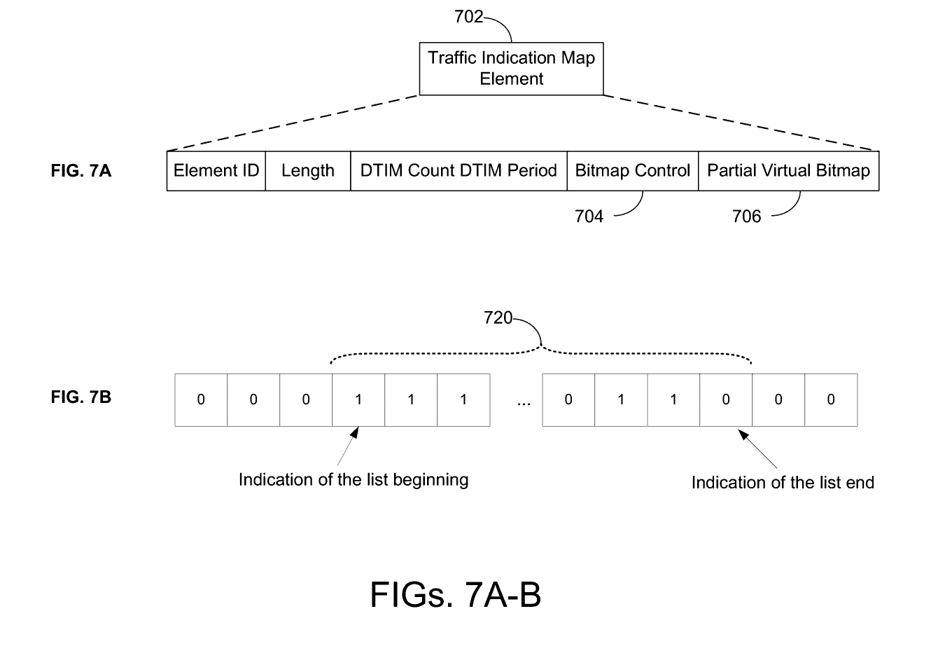

FIGS. 7A-B depict an illustrative schematic diagram of an exemplary traffic indication map element, in accordance with one or more example embodiments of the present disclosure.

In one embodiment, for reducing the decoding power, an ID list at the beginning of the aggregated frame in FIG. 6A (e.g., user ID list 610 for FIG. 6A) may be determined by a data frame aggregation system. The user ID list may contain the user ID indications for all the user devices whose small frames are aggregated in the aggregated multiuser frame. In one aspect, the user ID list may reuse the indication that may be found in other elements, for example, a traffic indication map element 702 in a beacon that may be received from a transmitting device, such as an AP. It is understood, that although the indication may be reused, the element may be packaged in a different message envelope associated with the data frame. Because user devices listen to at least one beacon before a listen interval, the AP may periodically send this traffic indication map on its beacons as an information element. The indication may include a bitmap control 704 in addition to a partial virtual bitmap 706.

In one embodiment, the user ID list may be placed in a control frame with a control field at the beginning of the frame. Each user may be assigned one bit in a virtual bitmap (e.g., partial virtual bitmap 706). A segment (e.g., segment 720 in FIG. 7B) of the full bitmap may be put in the partial virtual bitmap if all bits before and after the segment 720 are zeros. The offset for the segment 720 may be put in bitmap control 704. For reducing the overhead, the AP may assign adjacent bits to the user devices that usually have small frames. For example, out of 100 users, there may be 20 users with a large number of small frames. The AP may assign 20 consecutive bits for the 20 users. Then, the segment 720 of the bitmap may have only 20 bits. It is understood that the above descriptions are for purposes of illustration and are not meant to be limiting.

FIG. 7B depicts an illustrative schematic diagram of a user bitmap, in accordance with one or more example embodiments of the present disclosure. The user ID list may have a similar format as the traffic indication map element of FIG. 7A. The AP may specify the beginning of the segment 720 in the full bitmap and may also indicate which user devices are addressed by setting the value of the corresponding bits. The bitmap segment 720 may be used together with the HE-SIG-B indication using the one or more RA indexes described above. When user devices decode the control frame that includes the bitmap, the user devices may determine, based on knowing where the beginning of the bitmap is and their assigned bit in the bitmap, whether the user devices have data included in the received data frame. It is understood that the above descriptions are for purposes of illustration and are not meant to be limiting.

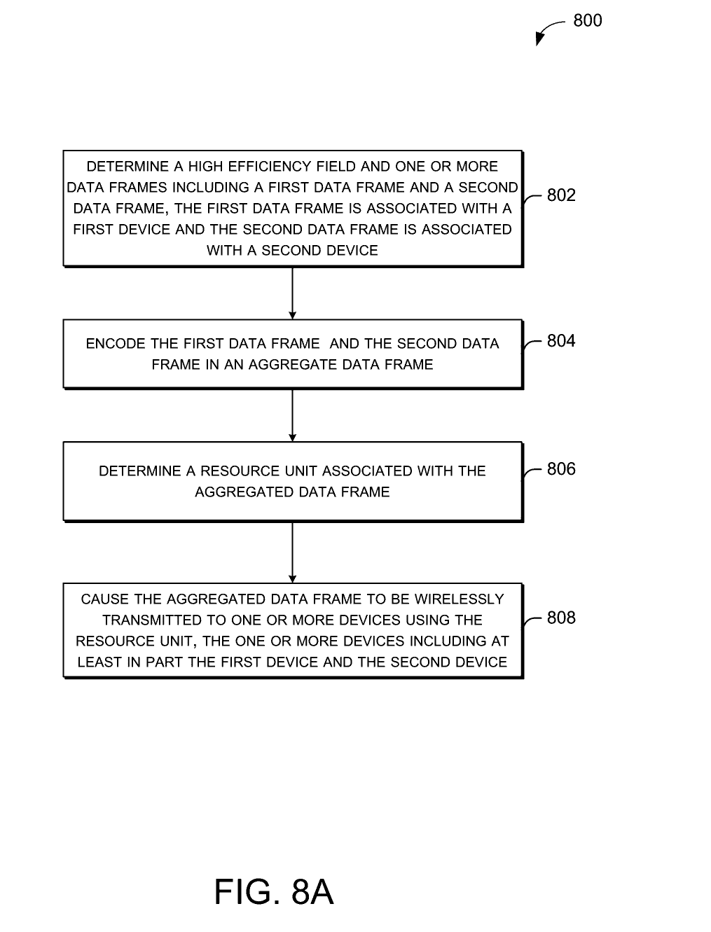

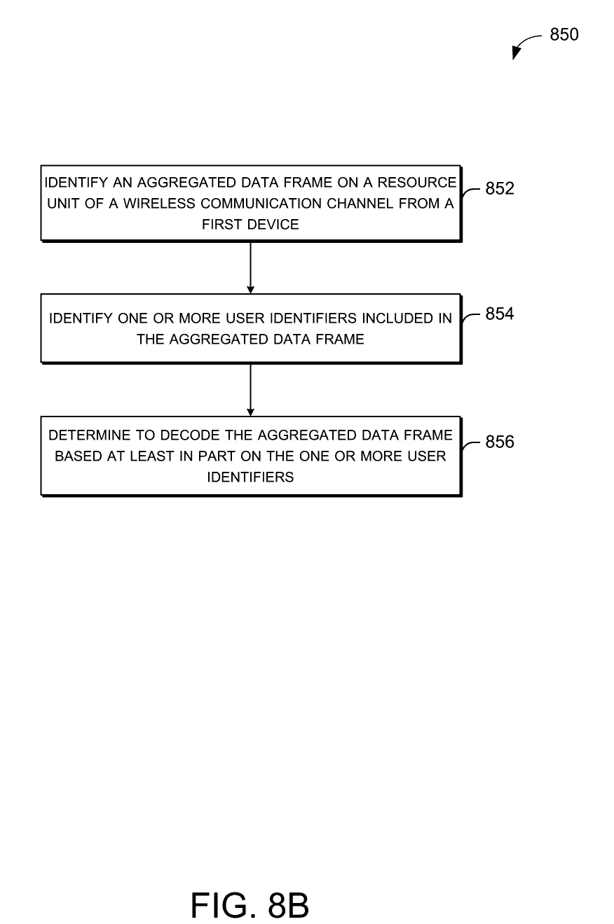

FIG. 8A depicts a flow diagram of illustrative process 800 for a data frame aggregation system in accordance with one or more embodiments of the disclosure.

At block 802, a device (e.g., AP 102 of FIG. 1) may determine a high efficiency field and one or more data frames, the one or more data frames including, at least in part, a first data frame and a second data frame, wherein the first data frame is associated with a first device and the second data frame is associated with a second device. During communications between the AP and one or more user devices (e.g., user devices 120 of FIG. 1), the AP may send one or more high efficiency frames using multiuser mode methods, such as OFDMA and MU-MIMO using an aggregated media access layer protocol data unit (A-MPDU). Different OFDMA RUs or MU-MIMO streams may use different MCSs to send data for different groups of user devices with different channel qualities, respectively. The AP may determine that one or more small data frames destined for one or more user devices having similar channel qualities may be aggregated together or sent over an OFDMA resource unit or over one or more MU-MIMO spatial streams. This may lower overhead and may enhance power consumption during sending these one or more small data frames. For example, the AP may determine a first data frame and a second data frame to be sent to the one or more user devices.

At block 804, the device may encode the first data frame and the second data frame in an aggregate data frame. The two data frames may be aggregated together in a single aggregated data frame in order to be sent over a resource unit (RU) to the one or more user devices. Typically, a high efficiency frame may contain one or more high efficiency signal fields such as an HE-SIG-B field. The HE-SIG-B field may contain a common part and one or more user specific parts. The HE-SIG-B field may describe attributes of the one or more frames, such as the channel width, modulation and coding, and whether the frame is a single- or multiuser frame. The HE-SIG-B field may include a common part and one or more user specific parts. For example, the common part may be common to all user devices, and the user specific parts may be specific to each user device receiving at least one of the one or more frames. The common part includes information for all users in the current PLCP protocol data unit (PPDU), and the user specific part includes the specific information for each specific user. For example, a resource allocation (RA) index may be included in the common part of the HE-SIG-B. The AP may utilize the RA index and may set it to indicate how the user specific parts are allocated with respect to the type of RU and spatial streams utilized for transmitting the data to the one or more user devices. For example, the RA indexes may indicate the type of RU (e.g., 26-tone RU, 52-tone RU, 106-tone RU, 242-tone RU, etc.) and how many user specific parts are sent over the RU. A receiving device may analyze the received RA index and may determine which RU and how many user specific parts are sent over that RU. This may assist the receiving device in properly decoding any received data frames. In some embodiments, the AP may determine one or more user identifiers associated with the first device and the second device. The one or more user identifiers may be in the form of an identification list included in the aggregated data frame. The identification list may include a list of user devices that may have data frames inside the aggregated frame. A receiving device may utilize that identification list in order to determine if its device ID is found in the identification list. This may indicate to the receiving device that it has data in the aggregated data frame that is addressed to that receiving device. In that case, the receiving device may decode the aggregated data frame in order to retrieve its data. On the other hand, if the receiving device inspects the identification list and does not find its device ID in the list, the receiving device may stop the decoding process and ignore the aggregated data frame. In another embodiment, the AP may utilize a bitmap that contains a plurality of bits, which may be set based on whether user data frames are found for the one or more user devices that may receive the aggregated data frame. The bitmap may allow a receiving device to determine whether a particular bit associated with that receiving device is set to 1 or 0 in order to determine whether the RU contains data addressed to that receiving device. In some embodiments, the AP may assign adjacent bits in the bitmap to the first device and the second device based at least in part on a common characteristic, wherein the common characteristic includes at least in part a data frame size. That is, if the data frames associated with the first device and the second device are small data frames, the AP may assign adjacent bits in the bitmap to those devices.

At block 806, the device may determine an RU associated with the aggregated data frame. For example, the AP may determine that the aggregated data frame may be sent over a particular RU. The RU utilized may be capable of carrying multiuser data frames. For example, a 106-tone RU may be utilized for multiple stream transmissions, and therefore may carry multiuser data frames. Additional RA indexes may be allocated in order to specify the type of RU utilized and the number of users' data frames sent over the RU.

At block 808, the device may cause the aggregated data frame to be wirelessly transmitted to one or more devices using the RU, the one or more devices including at least in part the first device and the second device. For example, multiple devices may receive the aggregated data frame and in order to preserve power consumption, a user device may determine, based on the RA index and on the identification list, whether a data frame is addressed to it in the aggregated data frame. The user device will only decode the aggregated data frame when the user device finds its device ID in the identification list. Based on the RA index, the receiving device may determine the type of RU utilized and the number of streams utilized.

FIG. 8B depicts a flow diagram of an illustrative process 850 for a data frame aggregation system, in accordance with one or more embodiments of the present disclosure.

At block 852, a receiving device (e.g., user device 120 or AP 102) may receive from another device, for example, an AP, data transmissions in the form of data frames. The receiving device may identify an aggregated data frame on a resource unit of a wireless communication channel from the AP. The aggregated data frame may contain multiple data frames associated with multiple user devices. The receiving device may first determine whether to decode or not decode the aggregated data frame based on whether the aggregated data frame includes at least one data frame addressed to the receiving device.

At block 854, the receiving device may identify one or more user identifiers included in the aggregated data frame. The one or more user identifiers may be in the form of an identification list included in the aggregated data frame. The identification list may include a list of user devices that may have data frames included in the aggregated frame. The receiving device may utilize that identification list in order to determine if its device ID is found in the identification list.

At block 856, the receiving device may determine to decode the aggregated data frame based at least in part on the one or more user identifiers. In case the receiving device determines that its device ID is found in the identification list, the receiving device may continue to decode the aggregated data frame. Locating its device ID in the identification list may indicate to the receiving device that it has data in the aggregated data frame. In that case, the receiving device may decode the aggregated data frame in order to retrieve its data. However, if the receiving device does not find its device ID in the identification list, the receiving device may stop decoding the received data frame.

In some embodiments, the receiving device may identify a bitmap included in the aggregated data frame. The bitmap may contain a plurality of bits, which may be set based on whether user data frames are found for the one or more user devices that may receive the aggregated data frame. The bitmap may allow the receiving device to determine whether a particular bit associated with that receiving device is set to 1 or 0 in order to determine whether the RU contains data addressed to that receiving device.

FIG. 9 shows a functional diagram of an exemplary communication station 900 in accordance with some embodiments. In one embodiment, FIG. 9 illustrates a functional block diagram of a communication station that may be suitable for use as an AP 102 (FIG. 1) or a user device 120 (FIG. 1) in accordance with some embodiments. The communication station 900 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, access point, access terminal, or other personal communication system (PCS) device.

The communication station 900 may include communications circuitry 902 and a transceiver 910 for transmitting and receiving signals to and from other communication stations using one or more antennas 901. The communications circuitry 902 may include circuitry that can operate the physical layer communications and/or medium access control (MAC) communications for controlling access to the wireless medium, and/or any other communications layers for transmitting and receiving signals. The communication station 900 may also include processing circuitry 906 and memory 908 arranged to perform the operations described herein. In some embodiments, the communications circuitry 902 and the processing circuitry 906 may be configured to perform the operations detailed in FIGS. 1-8.

In accordance with some embodiments, the communications circuitry 902 may be arranged to contend for a wireless medium and configure frames or packets for communicating over the wireless medium. The communications circuitry 902 may be arranged to transmit and receive signals. The communications circuitry 902 may also include circuitry for modulation/demodulation, upconversion/downconversion, filtering, amplification, etc. In some embodiments, the processing circuitry 906 of the communication station 900 may include one or more processors. In other embodiments, two or more antennas 901 may be coupled to the communications circuitry 902 arranged for sending and receiving signals. The memory 908 may store information for configuring the processing circuitry 906 to perform operations for configuring and transmitting message frames and performing the various operations described herein. The memory 908 may include any type of memory, including non-transitory memory, for storing information in a form readable by a machine (e.g., a computer). For example, the memory 908 may include a computer-readable storage device, read-only memory (ROM), random-access memory (RAM), magnetic disk storage media, optical storage media, flash-memory devices and other storage devices and media.

In some embodiments, the communication station 900 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 900 may include one or more antennas 901. The antennas 901 may include one or more directional or omnidirectional antennas, including, for example, dipole antennas, monopole antennas, patch antennas, loop antennas, microstrip antennas, or other types of antennas suitable for the transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 900 may include one or more of a keyboard, a display, a non-volatile memory port, multiple antennas, a graphics processor, an application processor, speakers, and other mobile device elements. The display may be an LCD screen including a touch screen.

Although the communication station 900 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 900 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 900 may include one or more processors and may be configured with instructions stored on a computer-readable storage device memory.

FIG. 10 illustrates a block diagram of an example of a machine 1000 or system upon which any one or more of the techniques (e.g., methodologies) discussed herein may be performed. In other embodiments, the machine 1000 may operate as a standalone device or may be connected (e.g., networked) to other machines. In a networked deployment, the machine 1000 may operate in the capacity of a server machine, a client machine, or both in server-client network environments. In an example, the machine 1000 may act as a peer machine in peer-to-peer (P2P) (or other distributed) network environments. The machine 1000 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer-readable medium containing instructions where the instructions configure the execution units to carry out a specific operation when in operation. The configuring may occur under the direction of the execution units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 1000 may include a hardware processor 1002 (e.g., a central processing unit (CPU), a graphics processing unit (GPU), a hardware processor core, or any combination thereof), a main memory 1004 and a static memory 1006, some or all of which may communicate with each other via an interlink (e.g., bus) 1008. The machine 1000 may further include a power management device 1032, a graphics display device 1010, an alphanumeric input device 1012 (e.g., a keyboard), and a user interface (UI) navigation device 1014 (e.g., a mouse). In an example, the graphics display device 1010, the alphanumeric input device 1012, and the UI navigation device 1014 may be a touch screen display. The machine 1000 may additionally include a storage device (i.e., drive unit) 1016, a signal generation device 1018 (e.g., a speaker), a data frame aggregation device 1019, a network interface device/transceiver 1020 coupled to antenna(s) 1030, and one or more sensors 1028, such as a global positioning system (GPS) sensor, a compass, an accelerometer, or other sensor. The machine 1000 may include an output controller 1034, such as a serial bus(e.g., universal serial bus (USB), parallel, or other wired or wireless (e.g., infrared (IR), near field communication (NFC), etc.) connection to communicate with or control one or more peripheral devices (e.g., a printer, card reader, etc.)).

The storage device 1016 may include a machine-readable medium 1022 on which is stored one or more sets of data structures or instructions 1024 (e.g., software) embodying or utilized by any one or more of the techniques or functions described herein. The instructions 1024 may also reside, completely or at least partially, within the main memory 1004, within the static memory 1006, or within the hardware processor 1002 during execution thereof by the machine 1000. In an example, one or any combination of the hardware processor 1002, the main memory 1004, the static memory 1006, or the storage device 1016 may constitute machine-readable media.

The data frame aggregation device 1019 may carry out or perform any of the operations and processes (e.g., processes 800 and 850) described and shown above. For example, the data frame aggregation device 1019 may be configured to utilize multiuser mode methods (e.g., OFDMA or multi-user multiple-input and multiple-output MIMO (MU-MIMO)) in order to aggregate small frames sent using a same PPDU. The data frame aggregation system may group small frames for user devices having similar channel qualities into an A-MPDU sent over an OFDMA resource unit (RU) or one or more MU-MIMO spatial stream(s) using a particular MCS. This may minimize and enhance power consumption as lower overhead may be used when sending one or more small frames. Different OFDMA RUs or MU-MIMO streams may use different MCSs to send data for different groups of user devices with different channel qualities, respectively. That is, based on various factors, one or more user devices' data may be grouped together and sent over OFDMA RU or MU-MIMO streams. These various factors include, in non-limiting examples, MCS values, channel quality, device type, device location, etc. It is understood that the above descriptions are for purposes of illustration and are not meant to be limiting.

The data frame aggregation device 1019 may be configured to utilize the high efficiency signal B (HE-SIG-B) field in the PHY header. The HE-SIG-B carries the device ID (also referred to as station (STA) ID) of each scheduled user device. A given user device may search the HE-SIG-B for its device ID. If a matching device ID is not found, the user device may stop decoding the HE-SIG-B in order to save power. The disclosed systems and methods may thus achieve lower complexity architectures, provide multiple MCSs for different user groups, save decoding power of unscheduled users, and reduce signaling and channel training overhead.

The data frame aggregation device 1019 may determine one or more resource allocation (RA) indexes for indicating the number of users assigned to a particular RU and the number of streams utilized for each user. A transmitting device may utilize an RA index value to notify the receiving device of the number of users and/or the number of streams on a particular RU.

The data frame aggregation device 1019 may determine a spatial stream allocation table for an RU having more than eight users (e.g., 10 users) in order to specify the number of spatial streams for each of the one or more user devices aggregated in one RU. In particular, because the number of MU-MIMO users per RU may, at most, be eight users, the spatial stream allocation table may include a stream allocation index that determines the number of streams that may be used by the one or more users in aggregation.

The data frame aggregation device 1019 may determine a spatial stream allocation table for an RU having less than eight users (e.g., four users) in order to introduce one or more stream allocation indexes to indicate the aggregation of the one or more users and the number of streams utilized by the users. An existing spatial stream allocation table may be enhanced by adding one or more entries to associate one or more stream allocation indexes with an aggregation of the one or more users.

The data frame aggregation device 1019 may determine a user identification list for user devices to indicate the user devices using a particular RU. The user identification list may contain at least in part a list of user devices utilizing the particular RU. For example, if there are four user devices utilizing an RU, the user identification list may include the device ID (also referred to as STA ID) of the user devices utilizing the RU. In that sense, when a receiving device receives the frame, it may analyze the user identification list to determine if it is included in that list. If there is a match in the ID, the receiving device may decode that RU in order to extract the data sent to it. Additionally, the user identification list may reuse a traffic indication map element found typically in a beacon frame sent from a transmitting device to a receiving device (e.g., from an access point to a user device).

The data frame aggregation device 1019 may determine a bitmap that allows a receiving device to determine whether a bitmap is set to 1 or 0 in order to determine whether the RU contains data addressed to that receiving device.

The data frame aggregation device 1019 may use a multiuser block acknowledgment (M-BA) to respond and acknowledge multiple uplink transmissions received from one or more user devices in response to the AP sending a trigger frame to those one or more user devices. A trigger frame may be carried using a preamble (e.g., a legacy preamble or a high efficiency HEW preamble), along with other signaling, such as resource allocation, to coordinate the uplink OFDMA operation. A trigger frame is simply a frame that contains a preamble and other fields that may be sent from an AP informing all user devices serviced by the AP that channel access is available. Essentially, the M-BA may be a multicast frame, and signaling is required in the HE-SIG-B to direct the one or more user devices to decode the M-BA in the designated RU. The one or more aggregation of multiple data frames of different user devices in an RU may be also implemented in conjunction with the M-BA. The signaling in the HE-SIG-B may be a group ID that may be allocated in the trigger frame. The signaling may use one or more RA indexes to indicate that a particular RU has a number of user devices' data frames. Once the one or more user devices receive the M-BA, they may retrieve the group ID found in HE-SIG-B to determine which frame contains their data.

While the machine-readable medium 1022 is illustrated as a single medium, the term “machine-readable medium” may include a single medium or multiple media (e.g., a centralized or distributed database, and/or associated caches and servers) configured to store the one or more instructions 1024.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read-only memory (ROM), random access memory (RAM), magnetic disk storage media, optical storage media, a flash memory, etc.

The term “machine-readable medium” may include any medium that is capable of storing, encoding, or carrying instructions for execution by the machine 1000 and that cause the machine 1000 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 1024 may further be transmitted or received over a communications network 1026 using a transmission medium via the network interface device/transceiver 1020 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone service (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 1020 may include one or more physical jacks (e.g., Ethernet, coaxial, or phone jacks) or one or more antennas to connect to the communications network 1026. In an example, the network interface device/transceiver 1020 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 1000 and includes digital or analog communications signals or other intangible media to facilitate communication of such software. The operations and processes (e.g., processes 800 and 850) described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

The term “access point” (AP) as used herein may be a fixed station. An access point may also be referred to as an access node, a base station, or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

According to example embodiments of the disclosure, there may be a device. The device may include at least one memory that stores computer-executable instructions, and at least one processor configured to access the at least one memory, wherein the at least one processor is configured to execute the computer-executable instructions to determine a high efficiency field and one or more data frames, the one or more data frames including, at least in part, a first data frame and a second data frame, wherein the first data frame is associated with a first device and the second data frame is associated with a second device. The at least one processor is configured to execute the computer-executable instructions to encode the first data frame and the second data frame into an aggregate data frame. The at least one processor is configured to execute the computer-executable instructions to determine a resource unit associated with the aggregated data frame. The at least one processor is configured to execute the computer-executable instructions to cause the aggregated data frame to be wirelessly transmitted to one or more devices using the resource unit, the one or more devices including at least in part the first device and the second device.

The implementations may include one or more of the following features. The at least one processor may be further configured to execute the computer-executable instructions to determine a high efficiency signal field included in the high efficiency field. The at least one processor may be further configured to execute the computer-executable instructions to determine a resource allocation index included in a common part associated with the high efficiency signal field, wherein the resource allocation index is associated with the resource unit and a number of devices using the resource unit. The at least one processor may be further configured to execute the computer-executable instructions to determine one or more user identifiers associated with the first device and the second device, wherein the one or more user identifiers are included in the aggregated data frame. The aggregated data frame is processed into an aggregated media access layer protocol data unit (A-MPDU). The resource unit is an Orthogonal Frequency-Division Multiple Access (OFDMA) resource unit. The aggregated data frame utilizes one or more multi-user multiple-input and multiple-output (MU-MIMO) spatial streams. The at least one processor may be further configured to execute the computer-executable instructions to determine a bitmap associated with the data frame, where the bitmap includes one or more bits. A first bit of the one or more bits is set to “1” indicating that the first data frame is encoded in the aggregated data frame and a second bit of the one or more bits is set to “1” indicating that the second data frame is encoded in the aggregated data frame. The at least one processor may be further configured to execute the computer-executable instructions to determine a third data frame of the one or more data frames, wherein the third data frame is associated with a third device. The at least one processor may be further configured to execute the computer-executable instructions to determine that the third data frame is not encoded in the aggregated data frame. The at least one processor may be further configured to execute the computer-executable instructions to setting a second bit of the one or more bits to “0” based at least in part on the determination that the third data frame is not encoded in the aggregated data frame. The at least one processor may be further configured to execute the computer-executable instructions to assign adjacent bits in the bitmap to the first device and the second device based at least in part on a common characteristic, wherein the common characteristic includes at least in part a data frame size. The device may further include a transceiver configured to transmit and receive wireless signals. The device may further include an antenna coupled to the transceiver.

According to example embodiments of the disclosure, there may be a non-transitory computer-readable medium storing computer-executable instructions which, when executed by a processor, cause the processor to perform operations. The operations may include identifying an aggregated data frame on a resource unit of a wireless communication channel from a first device. The operations may include identifying one or more user identifiers included in the aggregated data frame. The operations may include determining to decode the aggregated data frame based at least in part on the one or more user identifiers.

The implementations may include one or more of the following features. The operations for determining to decode the aggregated data frame may include performing a search for a pre-determined identifier of the one or more identifiers included in the aggregated data frame. The operations for determining to decode the aggregated data frame may include identifying a bitmap portion including a first bit. The computer-executable instructions cause the processor to further perform operations comprising stopping to decode the aggregated data frame if the search does not find the pre-determined identifier in the one or more identifiers. The operations for determining to decode the aggregated data frame may include determining that the first bit is set to “1.” the operations for stopping to decode the aggregated data frame may include operations for determining that the first bit is set to “0.”

According to example embodiments of the disclosure, there may be a method. The method may include determining a high efficiency field and one or more data frames, the one or more data frames including, at least in part, a first data frame and a second data frame, wherein the first data frame is associated with a first device and the second data frame is associated with a second device. The method may further include encoding the first data frame and the second data frame into an aggregate data frame. The method may further include determining a resource unit associated with the aggregated data frame. The method may further include causing the aggregated data frame to be wirelessly transmitted to one or more devices using the resource unit, the one or more devices including at least in part the first device and the second device.

The implementations may include one or more of the following features. The method may further include determining a high efficiency signal field included in the high efficiency field. The method may further include determining a resource allocation index included in a common part associated with the high efficiency signal field, wherein the resource allocation index is associated with the resource unit and a number of devices using the resource unit. The method may further include determining one or more user identifiers associated with the first device and the second device, wherein the one or more user identifiers are included in the aggregated data frame. The aggregated data frame is processed into an aggregated media access layer protocol data unit (A-MPDU). The resource unit is an Orthogonal Frequency-Division Multiple Access (OFDMA) resource unit. The aggregated data frame utilizes one or more multi-user multiple-input and multiple-output (MU-MIMO) spatial streams. The method may further include determining a bitmap associated with the data frame, where the bitmap includes one or more bits. A first bit of the one or more bits is set to “1” indicating that the first data frame is encoded in the aggregated data frame and a second bit of the one or more bits is set to “1” indicating that the second data frame is encoded in the aggregated data frame. The method may further include determining a third data frame of the one or more data frames, wherein the third data frame is associated with a third device. The method may further include determining that the third data frame is not encoded in the aggregated data frame. The method may further include setting a second bit of the one or more bits to “0” based at least in part on the determination that the third data frame is not encoded in the aggregated data frame. The method may further include assigning adjacent bits in the bitmap to the first device and the second device based at least in part on a common characteristic, wherein the common characteristic includes at least in part a data frame size.

In example embodiments of the disclosure, there may be an apparatus. The apparatus may include means for determining a high efficiency field and one or more data frames, the one or more data frames including, at least in part, a first data frame and a second data frame, wherein the first data frame is associated with a first device and the second data frame is associated with a second device. The apparatus may include means for encoding the first data frame and the second data frame into an aggregate data frame. The apparatus may include means for determining a resource unit associated with the aggregated data frame. The apparatus may include means for causing the aggregated data frame to be wirelessly transmitted to one or more devices using the resource unit, the one or more devices including at least in part the first device and the second device.

The implementations may include one or more of the following features. The apparatus may include means for determining a high efficiency signal field included in the high efficiency field. The apparatus may include means for determining a resource allocation index included in a common part associated with the high efficiency signal field, wherein the resource allocation index is associated with the resource unit and a number of devices using the resource unit. The apparatus may include means for determining one or more user identifiers associated with the first device and the second device, wherein the one or more user identifiers are included in the aggregated data frame. The aggregated data frame is processed into an aggregated media access layer protocol data unit (A-MPDU). The resource unit is an Orthogonal Frequency-Division Multiple Access (OFDMA) resource unit. The aggregated data frame utilizes one or more multi-user multiple-input and multiple-output (MU-MIMO) spatial streams. The apparatus may include means for determining a bitmap associated with the data frame, where the bitmap includes one or more bits. A first bit of the one or more bits is set to “1” indicating that the first data frame is encoded in the aggregated data frame and a second bit of the one or more bits is set to “1” indicating that the second data frame is encoded in the aggregated data frame. The apparatus may include means for determining a third data frame of the one or more data frames, wherein the third data frame is associated with a third device. The apparatus may include means for determining that the third data frame is not encoded in the aggregated data frame. The apparatus may include means for setting a second bit of the one or more bits to “0” based at least in part on the determination that the third data frame is not encoded in the aggregated data frame. The apparatus may include means for assigning adjacent bits in the bitmap to the first device and the second device based at least in part on a common characteristic, wherein the common characteristic includes at least in part a data frame size.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, comprising:
at least one memory that stores computer-executable instructions; and
at least one processor configured to access the at least one memory, wherein the at least one processor is configured to execute the computer-executable instructions to:
determine a high efficiency field and one or more data frames, the one or more data frames including, at least in part, a first data frame and a second data frame, wherein the first data frame is associated with a first device and the second data frame is associated with a second device;
encode the first data frame and the second data frame into an aggregate data frame;
determine a resource unit associated with the aggregated data frame; and
cause the aggregated data frame to be wirelessly transmitted to one or more devices using the resource unit, the one or more devices including at least in part the first device and the second device.

2. The device of claim 1, wherein the at least one processor is further configured to execute the computer-executable instructions to:
determine a high efficiency signal field included in the high efficiency field; and
determine a resource allocation index included in a common part associated with the high efficiency signal field, wherein the resource allocation index is associated with the resource unit and a number of devices using the resource unit.

3. The device of claim 1, wherein the at least one processor is further configured to execute the computer-executable instructions to determine one or more user identifiers associated with the first device and the second device, wherein the one or more user identifiers are included in the aggregated data frame.

4. The device of claim 1, wherein the aggregated data frame is processed into an aggregated media access layer protocol data unit (A-MPDU).

5. The device of claim 1, wherein the resource unit is an Orthogonal Frequency-Division Multiple Access (OFDMA) resource unit.

6. The device of claim 1, wherein the aggregated data frame utilizes one or more multi-user multiple-input and multiple-output (MU-MIMO) spatial streams.

7. The device of claim 1, wherein the at least one processor is further configured to execute the computer-executable instructions to determine a bitmap associated with the data frame, where the bitmap includes one or more bits.

8. The device of claim 7, wherein a first bit of the one or more bits is set to “1” indicating that the first data frame is encoded in the aggregated data frame and a second bit of the one or more bits is set to “1” indicating that the second data frame is encoded in the aggregated data frame.

9. The device of claim 7, wherein the at least one processor is further configured to execute the computer-executable instructions to:
determine a third data frame of the one or more data frames, wherein the third data frame is associated with a third device;
determine that the third data frame is not encoded in the aggregated data frame; and
setting a second bit of the one or more bits to “0” based at least in part on the determination that the third data frame is not encoded in the aggregated data frame.

10. The device of claim 7, wherein the at least one processor is further configured to execute the computer-executable instructions to assign adjacent bits in the bitmap to the first device and the second device based at least in part on a common characteristic, wherein the common characteristic includes at least in part a data frame size.

11. The device of claim 1, further comprising a transceiver configured to transmit and receive wireless signals.

12. The device of claim 11, further comprising an antenna coupled to the transceiver.

13. A non-transitory computer-readable medium storing computer-executable instructions which, when executed by a processor, cause the processor to perform operations comprising:
identifying an aggregated data frame on a resource unit of a wireless communication channel from a first device;
identifying one or more user identifiers included in the aggregated data frame; and
determining to decode the aggregated data frame based at least in part on the one or more user identifiers.

14. The non-transitory computer-readable medium of claim 13, wherein the operations for determining to decode the aggregated data frame includes performing a search for a pre-determined identifier of the one or more identifiers included in the aggregated data frame.

15. The non-transitory computer-readable medium of claim 13, wherein the operations for determining to decode the aggregated data frame includes identifying a bitmap portion including a first bit.

16. The non-transitory computer-readable medium of claim 14, wherein the computer-executable instructions cause the processor to further perform operations comprising stopping to decode the aggregated data frame if the search does not find the pre-determined identifier in the one or more identifiers.

17. The non-transitory computer-readable medium of claim 15, wherein the operations for determining to decode the aggregated data frame includes determining that the first bit is set to “1.”

18. The non-transitory computer-readable medium of claim 15, wherein the operations for stopping to decode the aggregated data frame includes operations for determining that the first bit is set to “0.”

19. A method comprising:
determining a high efficiency field and one or more data frames, the one or more data frames including, at least in part, a first data frame and a second data frame, wherein the first data frame is associated with a first device and the second data frame is associated with a second device;
encoding the first data frame and the second data frame into an aggregate data frame;
determining a resource unit associated with the aggregated data frame; and
causing the aggregated data frame to be wirelessly transmitted to one or more devices using the resource unit, the one or more devices including at least in part the first device and the second device.

20. The method claim 19, further including:
determining a high efficiency signal field included in the high efficiency field; and
determining a resource allocation index included in a common part associated with the high efficiency signal field, wherein the resource allocation index is associated with the resource unit and a number of devices using the resource unit.
